(19) United States
(12) Patent Application Publication
(10) Pub. No.: US 2023/0159139 A1
(43) Pub. Date: May 25, 2023

(54) METHOD AND SYSTEMS FOR IMPROVING DAMAGE STABILITY OF A SHIP

(71) Applicants: Dracos Vassalos, Glasgow (GB); John Jamieson Liggat, Glasgow (GB); Evangelos Boulougouris, Glasgow (GB); John Edward Cullen, Renfrew (GB); Donald Paterson, Isle of North Uist (GB)

(72) Inventors: Dracos Vassalos, Glasgow (GB); John Jamieson Liggat, Glasgow (GB); Evangelos Boulougouris, Glasgow (GB); John Edward Cullen, Renfrew (GB); Donald Paterson, Isle of North Uist (GB)

(21) Appl. No.: 16/084,156

(22) PCT Filed: Mar. 13, 2017
(86) PCT No.: PCT/GB2017/050681

§ 371 Date: Sep. 11, 2018

(30) Foreign Application Priority Data
Mar. 14, 2016 (GB) 1604329.1

(51) Int. Cl. B63B 43/16; B63B 43/04

(52) U.S. Cl. CPC B63B 43/16; B63B 43/04

(57) ABSTRACT

A foamable composition for injecting in a region of a ship, for example to prevent and/or reduce water ingress and/or progressive flooding in the ship so as to improve damage stability of the ship, is foamable to form a foam and is dissolvable in a removal composition. The provision of a foam, which can be dissolved by application of a removal composition, e.g., a solvent, may improve ease of removal of the foam, and therefore may reduce the cost and/or speed of reinstatement of the ship. The present invention also relates to a method of improving damage stability of a ship, the method comprising identifying one or more regions of the ship where injection of a material may lead to increase in ship stability, the material being impermeable to water and/or being capable of preventing migration of water.

### FIELD OF INVENTION

The present invention relates to systems and methods for improving stability of a ship following damage sustained by the ship. In particular, though not exclusively, the present invention relates to systems and methods for improving ship stability following water ingress or flooding sustained by a ship.

The present invention also relates to a foamable composition. In particular, though not exclusively, the present invention relates to a foamable composition suitable for injection in a region of a ship, e.g., following an emergency event.

The present invention also relates to methods and systems for injecting a foamable composition in a region of a ship, e.g., following an emergency event.

The present invention also relates to methods for removing foam, e.g., a foamed composition.

### BACKGROUND TO INVENTION

Whilst ship safety has generally been improving over the recent past, the survivability of a serious incident such as puncture in the hull of a ship as a result of collision or grounding resulting in water ingress is still unacceptably low.

Accidents involving ships such as “RoRo” (Roll-on-Roll-off) passenger ships tend to expose the vulnerability to flooding of existing ships. As a result, improvements to the design of ships have been sought, in particular aiming to improve damage stability. In the quest for improvements in damage stability, passive measures such as design improvements have traditionally been the only means to improve stability in a measurable manner. However, these improvements only affect newly constructed vessels, which comprise a low proportion of the fleet of vessels in operation around the world. Therefore, this approach only affects a small proportion of ships, leaving thousands of ships with severe vulnerability after damage and thus exposing passengers to a significant risk of loss of life and/or a significant economic loss due to loss of a ship and its cargo.

Many systems exist for improving buoyancy of a floating vessel. In particular, it is known to inject foam or foamable compositions in a damaged region of a vessel in order to displace water and/or restore buoyancy.

Chinese Patent Application No. CN 102745313 (Lin Ye) discloses a method for preventing a boat from sinking and a foam dispensing device. The method comprises injecting a curable foam into a damaged cabin of the boat.

Korean Patent Application No. KR 20120050111 (Samsung Heavy Industry) discloses an apparatus and a system for preventing sinking, provided to prevent or delay time for a ship to sink, by blocking sunken areas and generating buoyancy. The apparatus comprises a sinking sensor, a waterproofing and foaming unit, and an airbag.

UK Patent application Publication No. GB 2 418 890 (Nicholls) discloses an emergency buoyancy system for vessels. The safety system comprises an expandable material generator 60 and an envelope 50 arranged to receive the expandable material 70. Upon generation of the expandable material the envelope swells to a volume and extent whereby the envelope is forced to adapt to the shape, configuration and dimension of a non-flexible container, such as a cabin or baulk head, so as to substantially seal the container.

U.S. Pat. No. 6,327,988 (Seidel) discloses a watercraft with a deck and with a buoyancy chamber. In a first operating state, the buoyancy chamber contains air, and in a second operating state, the buoyancy chamber is filled with a foam which has a high cell volume with closed cells and a dimensionally stable state of aggregation.

While the above systems are capable of injecting foam into a damaged area of a vessel, these systems are only concerned with buoyancy. None of these systems consider the overall stability of the vessel that is ensuring survival of the ship and/or avoiding a fatal scenario such as sinking or capsizing. Rather, these systems are concerned with immediate restoration of buoyancy in the damaged area.

Another problem with these systems is that, upon recovery of the vessels, removal of the injected foam can be difficult, time consuming, and expensive. Typical foamed compositions such as polyurethane foams are not easy to remove, and removal of such foams typically involves mechanically removing the foam by, e.g., cutting portions of the foam. This can be particularly complex when the foam has been injected in regions or compartments containing machinery or other types mechanical equipment. In addition, polyurethane foam compositions typically involve an exothermic reaction upon foaming, which can be problematic in certain environments where a sudden increase in temperature is undesirable.

It is an object of at least one embodiment of the present invention to seek to obviate or at least mitigate one or more disadvantages in the prior art.

### SUMMARY OF INVENTION

According to a first aspect of the present invention there is provided use of a foamable composition for injecting in a region of a ship, the composition being foamable to form a foam, the foam being dissolvable in a removal composition.

As used herein, the term “ship” is not limited to any particular type or size of vessel, and will be understood to be synonymous to “vessel”, “watercraft” or the like.

The ship may comprise a passenger ship, e.g., a passenger ferry, a cargo ship, a military vessel, a fishing vessel, a vehicle-carrying ship, e.g., a RoRo (Roll-on-Roll-off) ship, a RoPax (Roll-on-Roll-off-Passenger) ship, or the like.

The use may comprise preventing and/or reducing water ingress and/or progressive flooding in a ship.

The use may comprise displacing water and/or may comprise improving buoyancy and/or stability of a ship. The foam may be configured for displacing water and/or restoring buoyancy of a ship. The foam may be waterproof and/or may be capable of preventing and/or reducing water ingress.

The provision of a foam, which can be dissolved by application of a removal composition, e.g., a solvent, may improve ease of removal of the foam, and therefore may reduce the cost and/or speed of reinstatement of the ship. In particular, this may help remove foam injected in regions or compartments containing machinery or other types mechanical equipment, in which removal of the foam by mechanical means may be difficult.

The removal composition and/or solvent may comprise an aqueous solution.

The removal composition and/or solvent may comprise an acidic solution.

The removal composition and/or solvent may comprise an aqueous acid solution.

The acid may comprise a strong acid, e.g., HCl, HNO₃, H₂SO₄, or the like.

In one embodiment, the solvent may comprise a solution of HCl (hydrochloric acid) in water.

The acidic solution may have a concentration of at least 1% v/v, e.g., at least 3% v/v, e.g., at least 5% v/v, e.g., at least 10% v/v, e.g., about 10-50% v/v, e.g., about 10-30% v/v. It will be appreciated that the concentration of the acidic solution to be used to dissolve the foam may depend on a number of parameters such as the precise type of foam composition being used, the speed of dissolution required, and the environment in which the foam has been discharged and/or injected. For example, a relatively low concentration may be sufficient to remove foam in a region containing expensive equipment that could be susceptible to being damaged by a high acid concentration, while a relatively high concentration may be desirable to remove foam more quickly in a region devoid of any apparatus.

The foamable composition may comprise a formaldehyde resin. A formaldehyde resin will be herein understood as a resin produced by reaction of formaldehyde and a co-reactant or co-monomer to form a polymeric resin.

The foamable composition may comprise a resin represented by Formula (I):

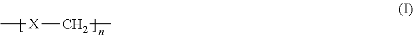

wherein X is selected from the group consisting of:
(i) a urea derivative;
(ii) an optionally substituted aromatic ring, optionally containing one or more heteroatoms; or
(iii) an optionally substituted melamine derivative.

In an embodiment, the foamable composition may comprise a urea-formaldehyde resin.

In an embodiment, X may be represented by Formula II:

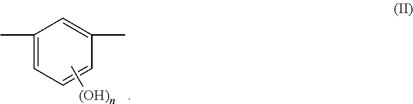

wherein n=0-4, preferably n=1-2.

In an embodiment, X may be represented by Formula IIa:

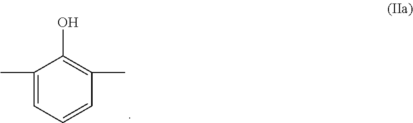

The foamable composition may comprise a phenolic resin, e.g. a phenol-formaldehyde resin.

In an embodiment, X may be represented by Formula IIb:

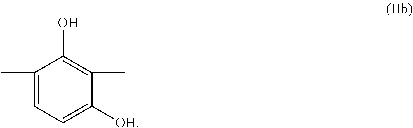

The foamable composition may comprise a resorcinol-formaldehyde resin.

In an embodiment, X may be represented by Formula III:

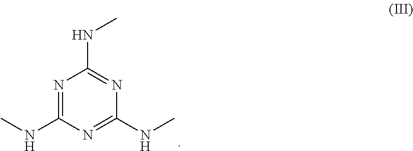

The foamable composition may comprise a melamine-formaldehyde resin.

Typically, the foamable composition may be provided as two or more separate components configured to be mixed and reacted at the point of delivery, e.g., in the region of the ship in which foam application is required and/or where foam is to be injected.

For example, a first composition may be provided in a first container.

The first composition may comprise or may consist essentially of a polymer or prepolymer.

The polymer or prepolymer may be provided as a solution, e.g., as an aqueous solution. The polymer or prepolymer may be provided as an aqueous solution at a concentration of approximately 10-60% by weight, e.g., 20-50% by weight, e.g. approximately 30-40% by weight.

In the case of a urea-formaldehyde resin, the first composition may comprise or may consist essentially of a urea-formaldehyde polymer or prepolymer. The urea-formaldehyde polymer or prepolymer may be provided as a solution, e.g., as an aqueous solution, at a concentration of approximately 10-60% by weight, e.g., 20-50% by weight, e.g. approximately 30-40% by weight.

In the case of a phenol-formaldehyde resin, the first composition may comprise or may consist essentially of a phenol-formaldehyde polymer or prepolymer. The phenol-formaldehyde polymer or prepolymer may be provided as a solution, e.g., as an aqueous solution, at a concentration of approximately 10-60% by weight, e.g., 20-50% by weight, e.g. approximately 30-40% by weight.

In the case of a resorcinol-formaldehyde resin, the first composition may comprise or may consist essentially of a resorcinol-formaldehyde polymer or prepolymer. The resorcinol-formaldehyde polymer or prepolymer may be provided as a solution, e.g., as an aqueous solution, at a concentration of approximately 10-60% by weight, e.g., 20-50% by weight, e.g. approximately 30-40% by weight.

In the case of a melamine-formaldehyde resin, the first composition may comprise or may consist essentially of a melamine-formaldehyde polymer or prepolymer. The melamine-formaldehyde polymer or prepolymer may be provided as a solution, e.g., as an aqueous solution, at a concentration of approximately 20-50% by weight, e.g. approximately 30-40% by weight.

In other embodiments, the first composition, e.g., the polymer or prepolymer, may be provided as a solid, e.g. flakes, powder, pellets, or the like. In such instance, the first composition may be dissolved in situ, e.g., in a solvent such as water.

A second composition may be provided in a second container.

The second composition may comprise, may consist essentially of or may consist of a crosslinking composition. The second composition, e.g., cross-linking composition, may consist essentially of or may consist of an aqueous acid solution, e.g. a solution of a weak acid in water. The second composition may comprise, may consist essentially of or may consist of an aqueous solution of a phosphate compound such as phosphoric acid and/or a salt of derivative thereof, an aqueous solution of a sulphonate compound such as dodecylbenzene sulphonic acid and/or a salt or derivative thereof, or the like. The aqueous acid solution may be provided at a concentration of about 1-10 v/v %, e.g., about 2-5 v/v %, e.g. about 3 v/v %.

Without wishing to be bound by theory, it is thought that reacting the first composition, e.g., a formaldehyde resin, with an acidic solution such as an aqueous solution of a weak acid in water may change the pH of the first composition, and may cause the first composition, e.g., formaldehyde resin, to crosslink. This may help forming stable foams, e.g., at the location in which foam is required. By crosslinking the first composition, e.g., a formaldehyde resin, with an acidic solution, the crosslinked resin, e.g., crosslinked formaldehyde resin, may be capable of being dissolved in a removal composition, such as an aqueous acid solution. The provision of a crosslinked foam composition which can be dissolved in a removal composition, e.g., in an aqueous acid solution, may improve ease of removal of the foam, and therefore may reduce the cost and/or speed of reinstatement of the ship.

The second composition may further comprise at least one foaming agent and/or at least one surfactant. The provision of at least one foaming agent and/or at least one surfactant may facilitate formation of foam upon mixing and/or reaction at the point of delivery.

The foamable composition may have an expansion ratio of at least 10, e.g., about 10-50, e.g., about 20-40, e.g., about 25-35.

The foamable composition may have a density of about 20-50 kg/m³. For example, in the case of a phenol-formaldehyde resin, the foamable composition may have a density of about 35-45 kg/m³, e.g. about 36-42 kg/m³. In the case of a urea-formaldehyde resin, the foamable composition may have a density of about 30-40 kg/m³. In the case of a melamine-formaldehyde resin, the foamable composition may have a density of about 10-80 kg/m³.

It will be appreciated that the density of the foam composition may depend on and/or may be tailored based on the ratio of the first composition and the second composition to the amount of gas used during foaming. The physical properties of the foam composition may also be controlled by altering the ratio of first composition/second composition/gas. Without wishing to be bound by theory, it is believed that a lower amount of gas may lead to foam having superior physical properties, while such improved physical properties come at the expense of higher foam density and thus increased weight and associated cost. Conversely, a higher amount of gas may lead to foam having inferior physical properties, but lower foam density and thus reduced weight and associated cost.

The foamable composition may have a shelf life of at least 3 months, preferably at least 6 months, e.g. about 6-12 months.

Without wishing to be bound by theory, it is believed that the shelf life of the foamable composition, e.g., of the first and/or of the second composition, may be affected by the concentration of one or more components thereof. For example, the shelf life of the first composition may be affected by the concentration of the polymer or prepolymer in the aqueous solution.

In some embodiments, the polymer or prepolymer may be provided as an aqueous solution at a concentration of approximately 10-40% by weight, e.g. approximately 20-30% by weight. By such provision, the first composition may be provided at a concentration suitable for and/or optimal for reacting with the second composition and/or for foaming, e.g., at the point of delivery.

In some embodiments, the first composition, e.g., polymer or prepolymer, may be provided as an aqueous solution at a concentration of approximately 30-60% by weight, e.g. approximately 40-50% by weight. Provision of the first composition at a relatively high concentration may increase the shelf-life of the first composition. However, the concentration of the first composition may be higher than required or higher than desirable for foaming. Thus, the first composition may be diluted with a solution, e.g., water, before foaming. Water may be provided and/or mixed with the first composition either at the point of injection, e.g., simultaneously with the second composition, and/or before, e.g., immediately before, the point of injection. By such provision, the volume of the container required for storing the first composition may be reduced, thus reducing equipment costs.

Water injected for diluting the first composition may comprise tap water, rain water, sea water, and/or any suitable type of water. The provision of sea water may be advantageous in that sea water may be obtained, e.g., pumped, directly from the sea, thus avoiding the need for storing fresh water onboard for the purpose of diluting the first composition.

In some embodiments, the first composition, e.g., the polymer or prepolymer, may be provided as a solid, e.g. flakes, powder, pellets, or the like. Provision of the first composition as a solid may increase the shelf-life of the first composition. In order to provide the first composition in a form suitable for foaming, e.g., as an aqueous solution, the first composition may be dissolved in a solvent, e.g., water, before foaming. Water may be provided and/or mixed with the first composition either at the point of injection, e.g., in situ and/or simultaneously with the second composition, and/or before, e.g., immediately before, the point of injection. By such provision, the volume of the container required for storing the first composition may be reduced, thus reducing equipment costs. Water injected for diluting the first composition may comprise tap water, rain water, sea water, and/or any suitable type of water. The provision of sea water may be advantageous in that sea water may be obtained, e.g. pumped, directly from the sea, thus avoiding the need for storing fresh water onboard for the purpose of dissolving the first composition.

The foam may be configured to be dissolvable in the solvent when the foam is contacted with the solvent in an amount of about 10-100 kg, e.g. 25-75 kg, e.g. 40-60 kg, e.g. about 50 kg of solvent per kg of foam.

The foam may be configured to be dissolvable in the removal composition when the foam is contacted with the removal composition by contacting the foam with the removal composition, e.g., by applying the removal composition to the foam, by spraying the removal composition onto the foam, and/or by injecting the removal composition into one or more portions of the foam.

The foam may be contacted with the removal composition at a predetermined temperature. For example, it is believed that contacting the foam with the removal composition at elevated temperature may increase the rate or speed of dissolution of the foam.

The predetermined temperature may be at least 25° C., e.g. at least 40° C., at least 50° C.

In one embodiment, the removal composition may be provided at the predetermined temperature, e.g. by heating the removal composition. In one embodiment, the foam may be heated prior to being contacted with the removal composition. For example, a portion of the compartment of the ship containing the foam may be heated prior to contacting the foam with the removal composition. Heating may be carried out in a number of ways, including, for example, heated air, steam, heated covers, or the like.

Various embodiments may be contemplated to allow the foam to be contacted with the removal composition at a desired temperature, in order to achieve a desired rate of dissolution. The predetermined temperature may depend on a number of parameters such as the specific foam composition, the removal composition.

According to a second aspect of the present invention there is provided a ship comprising a foamed composition or foam, the foamed composition or foam being dissolvable in a removal composition.

The foam composition or foam may be provided in a region of a ship, e.g. in a damaged region of a ship.

The foam may be provided in a non-damaged region of a ship, e.g. in a region adjacent to and/or in fluid communication with the damaged region. The foam may be waterproof and/or may be capable of preventing and/or reducing water ingress. The foam may be configured for displacing water and/or improving stability of a ship.

The features described herein in relation to any other aspect of the invention, can apply in respect of the ship according to a second aspect of the present invention, and are therefore not repeated here for brevity.

According to a third aspect of the present invention there is provided a method of improving stability of a ship, the method comprising identifying one or more regions of the ship where injection of a material may lead to increase in ship stability, the material being impermeable to water and/or being capable of preventing migration of water.

The method may comprise improving damage stability of the ship.

The material may be watertight, water resistant and/or water impermeable.

The method may comprise injecting the material in a region of the ship.

The material may comprise and/or may be a foamable composition.

As understood herein, the term “region” is not limited to an internal region of the ship, e.g., to a compartment of the ship, but is herein understood to include any region which may be in fluid communication with one or more compartments, e.g. with one or more critical compartments, of the ship. Thus, the term “region” will be herein understood to include not only compartments, but also any openings capable of facilitating flow of water, such as doors, windows, stairwells, elevator shafts, corridors, holes, or the like. Such openings may be the result of the integral design of the ship, e.g. doors, stairwell, elevator shafts, or may be present as a result of modifications made to the ship, for example holes or openings resulting from installations or repairs of, e.g., pipes, vents, cables, or the like.

The term “stability” will be herein understood as relating to the overall stability of a ship. While the term “buoyancy” relates to the ability of a ship or portion thereof to float, the term “stability” relates to the ability of a ship as a whole to survive and/or to avoid a fatal scenario such as sinking or capsizing. Thus, the term “stability” is not synonymous to the term “buoyancy”. While increasing buoyancy in a region of a ship may improve stability, increasing buoyancy in a region of a ship may in some cases decrease the overall stability of a ship, for example by creating an imbalance in buoyancy in the ship and increasing a risk of capsize.

The composition may be foamable to form a foam, the foam being dissolvable in a removal composition.

The foamable composition may comprise a composition described in the first aspect of the invention.

The foam may comprise a foam described in the first aspect of the invention.

The method may comprise providing the composition as two or more separate components. The method may comprise mixing and/or reacting the two or more components at the point of delivery, e.g., in the region of the ship in which the foamble composition is to be injected.

The method may comprise providing the first composition, which may comprise or may consist of a polymer or prepolymer.

The method may comprise providing the second composition, may comprise or may consist of a crosslinking composition. The second composition may comprise or may consist of an aqueous acid solution, e.g., a solution of a weak acid in water. The second composition may comprise an aqueous solution of a phosphate compound such as phosphoric acid and/or a salt of derivative thereof, an aqueous solution of a sulphonate compound such as dodecylbenzene sulphonic acid and/or a salt or derivative thereof, or the like.

The method may comprise mixing and/or reacting the first composition and the second composition.

The method may comprise diluting the first composition with a solution, e.g., water, before foaming.

The method may comprise providing and/or mixing water with the first composition either at the point of injection, e.g., simultaneously with the second composition, and/or before, e.g., immediately before, the point of injection. By such provision, the volume of the container required for storing the first composition may be reduced, thus reducing equipment costs. Water injected for diluting the first composition may comprise tap water, rain water, sea water, and/or any suitable type of water. The provision of sea water may be advantageous in that sea water may be obtained, e.g. pumped, directly from the vicinity of the ship, thus avoiding the need for storing fresh water onboard for the purpose of diluting the first composition.

The method may comprise dissolving the first composition in a solvent, e.g., water, before foaming. This may be required if the first composition, e.g. polymer or prepolymer, is provided as a solid, e.g., flakes, powder, pellets, or the like. Provision of the first composition as a solid may increase the shelf-life of the first composition. The method may comprise providing and/or mixing water with the first composition either at the point of injection, e.g., simultaneously with the second composition, and/or before, e.g., immediately before, the point of injection. By such provision, the volume of the container required for storing the first composition may be reduced, thus reducing equipment costs. Water injected for diluting the first composition may comprise tap water, rain water, sea water, and/or any suitable type of water. The provision of sea water may be advantageous in that sea water may be obtained, e.g., pumped, directly from the vicinity of the ship, thus avoiding the need for storing fresh water onboard for the purpose of dissolving the first composition.

The method may comprise crosslinking the first composition.

The method may comprise foaming the composition.

The method may comprise providing and/or injecting a gas, e.g., air, carbon dioxide, nitrogen, or the like, to foam and/or to help foam the composition.

In one embodiment, the gas may be provided in a gas storage tank and the gas may be maintained under pressure in order to decrease volume and permit more gas to be contained within the gas storage tank.

In another embodiment, the gas may be provided via a compressor, e.g., an air compressor.

The method may comprise mixing the gas in a/the stream of the composition, or in a/the stream of the first composition and/or the second composition.

The method may comprise controlling the density of the foam composition.

The method may comprise controlling the ratio of first composition/second composition/gas during foaming. Without wishing to be bound by theory, it is believed that a lower amount of gas may lead to foam having superior physical properties, while such improved physical properties come at the expense of higher foam density and thus increased weight and associated cost. Conversely, a higher amount of gas may lead to foam having inferior physical properties, but lower foam density and thus reduced weight and associated cost.

The method may comprise altering the ratio of first composition/second composition/gas during foaming. By such provision, the density of the resulting foam may be adjusted and/or controlled during foaming. This may be desirable when difference foam densities are desirable at different stages of foam injection and/or of the foaming process. For example, higher density may be desirable when injecting foam in a damaged region of the ship and/or in a region which would result in the foam being subjected to challenging structural conditions, e.g., high pressure, while lower density may be desirable when injecting foam in a region of the ship requiring a large amount of foam, but not requiring foam having high structural properties. It will be appreciated that the ratio of first composition/second composition/gas during foaming may be altered and/or adjusted during foaming to obtain a desired foam density throughout the foaming process.

The method may comprise the preliminary step of determining a location suitable for injection of the material, e.g. foam, following an emergency event, e.g., following damage to a region of the ship.

The method may comprise performing a vulnerability analysis.

As used herein, the term “vulnerability” will be understood as “the probability that a ship may capsize within a certain time when subjected to any feasible flooding case”. As such, “vulnerability” may contain and/or provide information on a number of parameters, e.g., substantially all parameters, that significantly affect damage ship survivability.

The method, e.g., the vulnerability analysis, may comprise mapping and/or modelling a ship, e.g., mapping and/or modelling an internal geometry and/or space of a ship.

The method, e.g., the vulnerability analysis, may comprise dividing the ship, e.g., internal geometry and/or space thereof, into one or more compartments, preferably into a plurality of compartments. The method, e.g., the vulnerability analysis, may comprise mapping and/or modelling the one or more compartments, e.g., the plurality of compartments, of the ship.

The method, e.g., the vulnerability analysis, may comprise mapping and/or modelling one or more spaces and/or elements within one or more compartments, e.g., within each of the compartments. In an embodiment, the method, e.g., the vulnerability analysis, may comprise mapping and/or modelling all spaces and/or elements within each of the compartments.

The spaces and/or elements may comprise equipment including non-buoyant volumes such as tanks, machinery, pipes, and/or other equipment. By such provision an accurate model of the volume available for potential flooding can be created and/or designed.

The spaces and/or elements may comprise openings, e.g., openings to and/or from and/or in fluid communication with one or more compartments, e.g., each of the compartments. By such provision, an accurate model of the potential for progressive flooding can be created and/or designed. The term “progressive flooding” will be herein understood as the propensity for a fluid, e.g., water, to flow from one compartment to another compartment, from one region of a compartment to another region of the compartment, and/or from one region of the ship to one or more compartments. For example, it will be understood that, while damage to a given region or compartment of the ship and water ingress in that region or compartment may not result in itself in significant risk to the overall stability of the ship, the existence of an opening, e.g., a door, window, stairwell, elevator shaft, corridor, hole, or the like, may cause progressive flooding to a critical region of the ship, e.g., to a critical compartment, which may result in the overall stability of the ship being compromised.

Thus, the method may allow identification of design vulnerabilities, e.g., of boundaries and/or restrictions to flooding and of potential progression of flooding.

The method may be automated and/or computerised.

The method may comprise using a computer system.

The method may comprise input of the map and/or model of the internal geometry and/or space of the ship, into the computer system.

The method may comprise input of one of more ship characteristics in the computer system. The one or more ship characteristics may comprise overall length, length between perpendiculars, breadth, subdivision draught, lightweight, deadweight, total passengers, and/or total crew.

The method may comprise determining the likelihood of the ship surviving damage to one or more compartments.

In one embodiment, the method may comprise automated determination of likelihood of the ship surviving damage to one or more compartments. The method, e.g., automated determination of likelihood of the ship surviving damage to one or more compartments, may be based on map and/or model of the internal geometry and/or space of the ship, and on the one of more ship characteristics.

The method may comprise a sensitivity analysis.

The term “sensitivity analysis” will be herein understood as an analysis leading to identification and/or ranking of compartments where injection of the material, e.g., foam may lead to an increase in ship stability.

The method, e.g., sensitivity analysis, may comprise identification and/or ranking of regions or compartments where injection of the material, e.g., foam may lead to maximum stability recovery. Compartments in which damage may lead to high risk to the stability of the ship, in which damage may lead to loss of the ship, and/or where injection of foam may lead to maximum stability recovery, will be herein termed “critical compartments”.

The method, e.g., sensitivity analysis, may comprise determination of a desired and/or minimum amount and/or volume of the material, e.g., foam to be injected to achieve a predetermined increase in ship stability.

The method, e.g., sensitivity analysis, may comprise determination of an optimum amount and/or volume of foam to be injected to achieve a predetermined increase in ship stability.

The method, e.g., sensitivity analysis, may comprise determination of an amount and/or volume of the material, e.g., foam to be injected for which buoyancy restoration per volume of foam will lead to maximum increase in stability.

The method may comprise providing a computer program comprising and/or being associated with the sensitivity analysis.

The method may comprise providing a system comprising the computer program and/or sensitivity analysis.

The method may comprise detecting damage to a region of a ship, e.g., to one or more compartments, e.g. critical compartments, and/or openings or regions in fluid communication with such compartments. Detection may be carried out by one or more sensors. One or more sensors may be provided in one or more regions, openings or compartments, e.g., in one or more critical compartments, e.g., in the critical compartment(s).

The method may comprise determining the risk and/or likelihood of survival of the ship based on the damage detected. The method may comprise determining the risk and/or likelihood of survival of the ship using the system, e.g. automated system, and/or the computer program.

The method may comprise identifying one or more regions of the ship and/or compartments where injection of foam may lead to increase in ship stability. The method may comprise using the system, e.g., automated system, and/or the computer program to identify one or more compartments where injection of foam leads to an increase in ship stability.

The method may comprise taking an action. In one embodiment, the method may comprise a user, e.g., a crew member, taking an action. The action may be based on the sensitivity analysis, and/or on the information generated by the computer program and/or system.

The method may comprise injecting the material, e.g. foam, in a region of a ship.

The method may comprise injecting foam in one or more damaged compartments.

The method may comprise injecting the material, e.g., foam in the damaged compartment or compartments. This may be adequate if damage occurs in a critical compartment or critical compartments in order to displace water therefrom and improve stability, or if damage occurs in a compartment or compartments in fluid communication with a critical compartment in order to prevent water from entering the critical compartment. Injecting foam in a damaged compartment may restrict or confine water at the bottom of the compartment, thus preventing upwards egress or flow of water.

The method may comprise injecting the material, e.g., foam in a non-damaged region of the ship. In an embodiment, the method may comprise injecting foam in one or more non-damaged regions or compartments, e.g., in one or more compartments adjacent to and/or in fluid communication with the damaged compartment or compartments. Such non-damaged regions or compartments will be understood to include not only compartments as such, but also regions which may allow progressive flooding to a critical region of the ship, e.g., to a critical compartment, and will therefore be understood to include regions such as doorways, stairwells, elevator shafts, corridors, openings, holes, or the like. This may be adequate if damage occurs in a non-critical compartment or non-critical compartments in fluid communication with a critical compartment or critical compartments. In such instance, while injection of foam in the non-critical compartment or non-critical compartments may not be required to maintain the overall stability of the ship, injection of foam in the one or more compartments adjacent to and/or in fluid communication with the damaged compartment or compartments prevents water ingress into and/or displaces water from the critical compartment or critical compartments. This may ensure survival of the ship, while minimising the amount of foam injected in the ship, thereby reducing costs and increasing the rapidity of subsequent reinstatement of the ship.

The method may comprise not injecting the material, e.g., foam in any region or compartment of the ship, e.g., either in a damaged compartment or compartments, or in any compartment or compartments in fluid communication with the damaged compartment or compartments. This may be adequate if damage occurs in a non-critical region of the ship such as a non-critical compartment or non-critical compartments. Since such a scenario would not compromise the overall stability of the ship and would not lead to the loss of the ship, injection of foam is not required. Therefore, avoiding systematic injection of foam following damage to a region of the ship may reduce costs, and substantially quicker subsequent reinstatement of the ship.

When the method comprises injecting the material, e.g., foam in a region of the ship, the method may comprises injecting the material in a region of the ship so as to minimise the overall amount of material required to improve the stability of the ship. For example, if water could flow from a non-critical region of the ship to a critical region of the ship through an opening, e.g. a hole, the method may comprise injecting the material so as to fill, seal and/or plug the opening. This may avoid the need to inject large amounts of material, e.g. foam, into the critical compartment, thus reducing costs associated with the material used as well as costs and time associated with the reinstatement of the ship.

The features described herein in relation to any other aspect of the invention, can apply in respect of the method according to a third aspect of the present invention, and are therefore not repeated here for brevity.

According to a fourth aspect of the present invention there is provided a system for improving stability of a ship, the system comprising:

a computer system configured to determine a location suitable for injection of a material following an emergency event; and

a user interface configured to allow a user to inject a material in a region of a ship, the material being impermeable to water and/or being capable of preventing migration of water.

The material may be watertight, water resistant and/or water impermeable. The material may comprise and/or may be a foamable composition.

The composition may be foamable to form a foam, the foam being dissolvable in a removal composition.

The foamable composition may comprise a composition as described in the first aspect of the invention.

The computer system may be configured to determine the likelihood of the ship surviving damage to one or more compartments.

The computer system may comprise and/or may be equipped with a map and/or model of the ship, e.g. a map and/or model of an internal geometry and/or space of the ship.

The map and/or model may comprise one or more compartments, preferably a plurality of compartments.

The map and/or model may comprise one or more spaces and/or elements within one or more compartments, e.g., within each of the compartments. In an embodiment, the map and/or model may comprise all spaces and/or elements within each of the compartments.

Thus, the map may provide an indication of design vulnerabilities of the ship, e.g., of boundaries and/or restrictions to flooding and of potential progression of flooding.

The computer system may comprise and/or may be equipped with data representing one of more ship characteristics. The one or more ship characteristics may comprise overall length, length between perpendiculars, breadth, subdivision draught, lightweight, deadweight, total passengers, and/or total crew.

The computer system may be configured to determine the likelihood of the ship surviving damage to one or more regions of the ship, e.g., to one or more compartments.

The computer system may be configured to identify and/or rank regions of the ship and/or compartments where injection of the material, e.g., foam may lead to stability recovery, e.g. maximum stability recovery.

The computer system may be configured to identify and/or rank openings, closure or plugging of which may restrict flooding or prevent progressive flooding, e.g., to a critical region or compartment.

The computer system may be configured to determine a desired and/or minimum amount and/or volume of the material, e.g., foam to be injected to achieve a predetermined increase in ship stability.

The computer system may be configured to determine an optimum amount and/or volume of the material, e.g., foam to be injected to achieve a predetermined increase in ship stability.

The computer system may be configured to determine an amount and/or volume of the material, e.g., foam to be injected for which buoyancy restoration per volume of foam will lead to maximum increase in stability.

The system may comprise one or more sensors configured to detect damage to a region of a ship, e.g., to one or more compartments. One or more sensors may be provided in one or more compartments, e.g., in one or more critical compartments, e.g., in the critical compartment(s).

The system, e.g., computer system, may be configured to determine the risk and/or likelihood of survival of the ship based on the damage detected.

The system, e.g., computer system, may be configured to identify one or more regions or compartments where injection of the material, e.g., foam may lead to increase in ship stability.

The system, e.g., user interface, may be configured to allow a user, e.g. a crew member, to take an action. The action may be based on the sensitivity analysis, and/or on the information generated by the computer program and/or system.

The system, e.g., user interface, may be configured to allow a user to select one or more compartments where foam is to be injected.

The system may be associated with and or may be integrated to a ship monitoring system, e.g., to a ship's Safety Management System (SMS). By such provision, a user may easily use and/or interact with the system within an existing and/or familiar environment.

In an emergency, the system may generate or trigger a signal, e.g., an alarm, informing a user of the emergency.

Typically, the system, e.g. the user interface, may present a user with information to identify one or more regions or compartments where injection of the material, e.g., foam may lead to increase in ship stability.

Typically, the system may be configured to allow a dedicated user, e.g., the captain, to take action, e.g., to initiate injection of the material, e.g., foam in one or more regions, e.g., in the identified regions

The system may comprise one or more storage container. One or more storage containers may be configured for storing the foamable composition.

In one embodiment, the system may comprise a plurality of containers. One or more containers may be configured to store one or more components of the foamable composition, and one or more other containers may be configured to store one or more other components of the foamable composition.

The system may comprise a plurality of containers in a plurality of compartments.

In one embodiment, the system may comprise a plurality of containers in each of the compartments in which the foamable composition may be injected.

In another embodiment, the system may comprise a plurality of containers in a first compartment for injection in one or more second compartments. The first and second compartments may be the same of different.

In one embodiment, the system may comprise a first container configured to store the first composition, which may comprise or may consist of a polymer or prepolymer.

The system may comprise a second container configured to store the second composition, which may comprise or may consist of a crosslinking composition. The second composition may comprise or may consist of an aqueous acid solution, e.g., a solution of a weak acid in water.

The system may be configured for mixing and/or reacting the first composition and the second composition, e.g., upon activation by a user via the user interface.

The system may comprise a third container. The third container may be configured for allowing dilution the first composition with a solution, e.g., water, before foaming.

The system may comprise one or more pumps configured for pumping the foamable composition, e.g., the first composition and/or the second composition, from the one or more containers.

In one embodiment, each container may be equipped with and/or may be associated with an associated pump for pumping and/or delivering an associated composition.

In one embodiment, the system may comprise a pump configured for pumping and/or delivering sea water. The provision of sea water may be advantageous in that sea water may be obtained, e.g., pumped, directly from the vicinity of the ship, thus avoiding the need for storing fresh water onboard for the purpose of diluting the first composition.

The system may comprise a fourth container configured for storing a solvent, e.g., water, for dissolving the first composition before foaming. This may be required if the first composition, e.g., polymer or prepolymer, is provided as a solid, e.g., flakes, powder, pellets, or the like.

The system may comprise one or more conduits, e.g., pipes, tubes or the like, for carrying a fluid from an associated container to a predetermined location, e.g., a discharge location.

The system may comprise a discharge device, e.g. a nozzle, tap, or the like, for discharging, e.g., injecting, the foaming composition.

The system may comprise a gas injection mechanism for supplying, providing and/or injecting a gas, e.g., air, carbon dioxide, nitrogen, or the like, to foam and/or to help foam of the composition.

In one embodiment, the system may comprise a fifth container configured to store the gas, optionally under pressure.

In another embodiment, the system may comprise a compressor, e.g., an air compressor, configured to provide the gas, e.g. air.

In an embodiment, the each of the compartments in which the foamable composition may be injected, may be equipped with and/or may comprise an associated first container, second container, third container, fourth container, pump(s), conduits, gas injection mechanism, and/or discharge device. In other embodiments, a first container, second container, third container, fourth container, pump(s), and/or conduits, and/or gas injection mechanism, may be associated with a plurality of compartments.

The features described herein in relation to any other aspect of the invention, can apply in respect of the system according to a fourth aspect of the present invention, and are therefore not repeated here for brevity.

According to a fifth aspect of the present invention there is provided a method for removing a foam from a region of a ship, the method comprising contacting the foam with a removal composition.

The method may comprise dissolving the foam.

The method may comprise applying the removal composition to the foam.

The method may comprise spraying the removal composition onto the foam.

The method may comprise injecting the removal composition into one or more portions of the foam.

The method may comprise contacting the foam with the removal composition in an amount of about 10-100 kg, e.g. 25-75 kg, e.g. 40-60 kg, e.g. about 50 kg of solvent per kg of foam.

The removal composition and/or solvent may comprise an aqueous solution.

The removal composition and/or solvent may comprise an acidic solution. The removal composition and/or solvent may comprise an aqueous acid solution.

The acid may comprise a strong acid, e.g., HCl, HNO₃, H₂SO₄, or the like.

In one embodiment, the solvent may comprise solution of HCl in water.

The acidic solution may have a concentration of at least 1% v/v, e.g., at least 3% v/v, e.g., at least 5% v/v, e.g., at least 10% v/v, e.g., about 10-50% v/v, e.g., about 10-30% v/v. It will be appreciated that the concentration of the acidic solution to be used to dissolve the foam may depend on a number of parameters such as the precise type of foam composition being used, the speed of dissolution required, and the environment in which the foam has been discharged. For example, a relatively low concentration may be sufficient to remove foam in a region containing expensive equipment that could be susceptible to being damaged by a high acid concentration, while a relatively high concentration may be desirable to remove foam more quickly in a region devoid of any apparatus.

The features described herein in relation to any other aspect of the invention, can apply in respect of the method according to a fifth aspect of the present invention, and are therefore not repeated here for brevity.

### BRIEF DESCRIPTION OF DRAWINGS

Embodiments of the invention will now be given by way of example only, and with reference to the accompanying drawing, which are:

FIG. 1 a schematic representation of an example of a vulnerability assessment;

FIGS. 2 and 3 an illustration of design vulnerability with reference to MV Estonia;

FIG. 4 a schematic representation of a method for improving stability of a ship according to an embodiment of the present invention;

FIG. 5 a schematic representation of a system for improving stability of a ship according to an embodiment of the present invention;

FIGS. 6 and 7 a perspective view of an embodiment of the injection system of FIG. 5;

FIGS. 8-12 a first embodiment of a sensitivity analysis and implementation of a system and method according to the present invention, for a first type of vessel;

FIGS. 13-19 a second embodiment of a sensitivity analysis and implementation of a system and method according to the present invention, for a second type of vessel; and

FIGS. 20-25 a third embodiment of a sensitivity analysis and implementation of a system and method according to the present invention, for a third type of vessel.

### DETAILED DESCRIPTION OF DRAWINGS

As used herein, the term “vulnerability” is understood to refer to the probability that a ship may capsize within a certain time when subjected to any feasible flooding case.

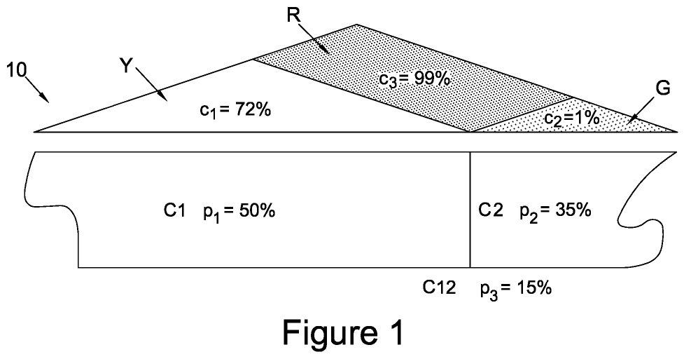

Referring to FIG. 1, there is shown a schematic representation an example of a vulnerability assessment.

The basic example shown in FIG. 1 illustrates a ship 10, and depicts 3 possible flooding cases C1 (rear), C2 (front) and C12 (front and rear) following damage to the ship 10.

Each event is associated with a known frequency of occurrence, which is available through statistics. In the example shown in FIG. 1, the probability p₁ of C1 (damage to rear) is 50%, the probability p₂ of C2 (damage to front) is 35%, and the probability p₃ of C12 (damage to front and rear) is 15%.

Each event is also associated with a known probability that the event will cause loss of the ship 10, e.g., within a predetermined time period (in this example 3 hours). In the example shown in FIG. 1, the probability c₁ of loss following C1 (damage to rear) is 72%, the probability c₂ of loss following C2 (damage to front) is 1%, and the probability c₃ of loss following C12 (damage to front and rear) is 99%.

As shown in FIG. 1, the probability of loss in each scenario is represented by a corresponding triangle c₁, c₂ and c₃. Each triangle relates to the probability of loss following damage to a specific ship compartment or specific compartments. The location and base of each triangle relate to the size and location of the damage.

A red (R) triangle indicates that the damage depicted by the base of the triangle will likely result in loss of the ship. A yellow (Y) triangle indicates that the damage depicted by the base of the triangle may or may not result in loss of the ship. A green (G) triangle indicates that the damage depicted by the base of the triangle will likely not result in loss of the ship.

Based on this information, the vulnerability to collision flooding of the example of FIG. 1 is:

V=0.5×0.72+0.35×0.01+0.15×0.99=51.2%

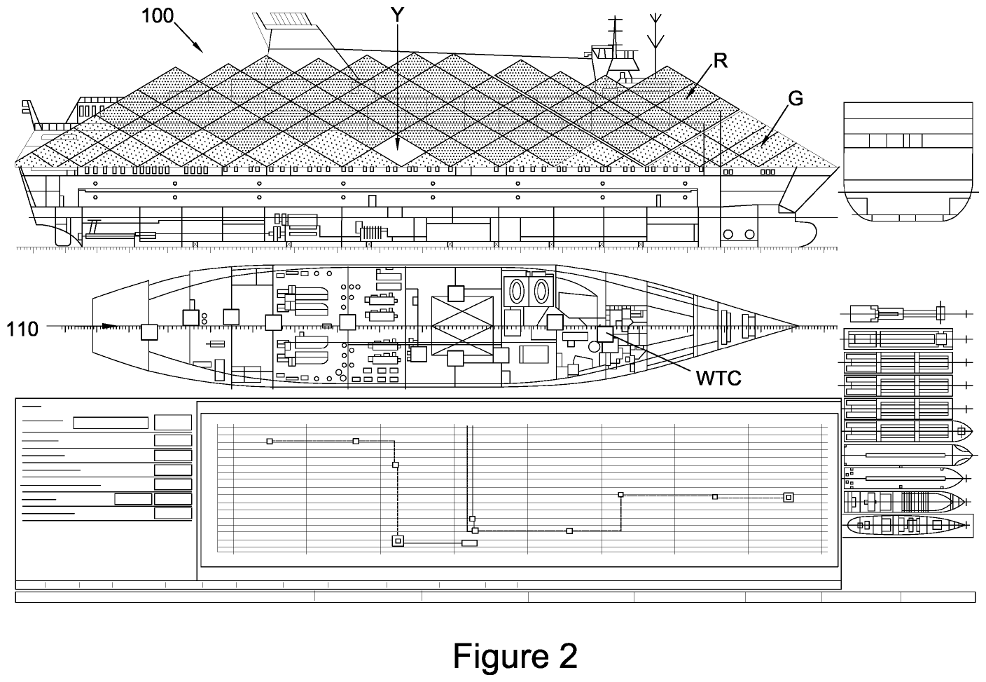

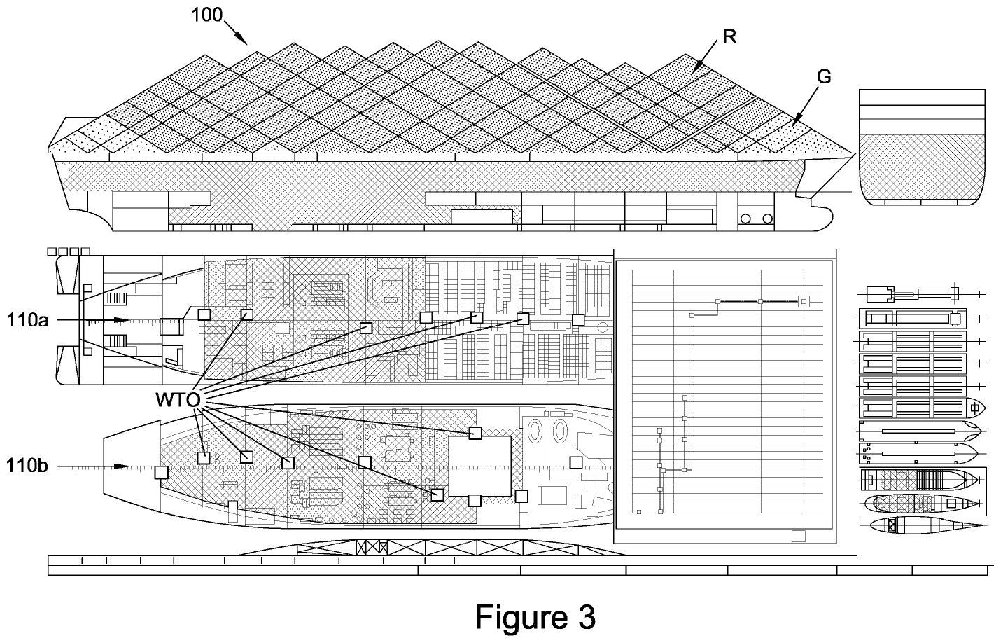

FIGS. 2 and 3 illustrate design vulnerability of a concrete example, the MV Estonia, denoted 100, which sank in 1994.

FIG. 2 illustrates design vulnerability of MV Estonia 100 operated under normal conditions, that is, following the normal guidelines for operation. As can be seen in the plan view 110 of FIG. 2, under normal conditions, a number of watertight (WT) doors represented by squares are closed (WTC).

FIG. 3 illustrates design vulnerability of MV Estonia 100 as operated at the time of her loss. As can be seen in the plan views 110a and 110b of FIG. 3, as operated at the time of her loss, watertight doors comprise a number of doors that are closed (WTC) and a number of doors that are open (WTO). These open doors can cause “progressive flooding” in an emergency event, allowing water to flow from one compartment to another compartment.

In the configuration of FIG. 3, the vulnerability of the vessel was at 68%, i.e., 3.5 times higher than her design vulnerability of 19% depicted in FIG. 2.

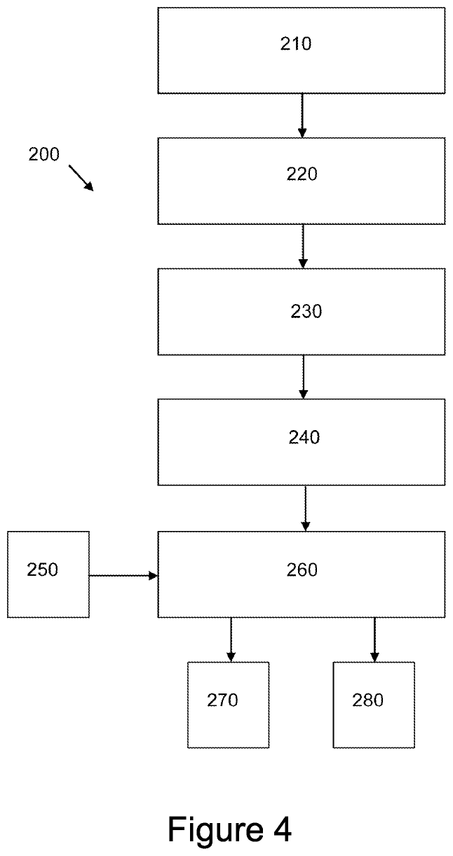

Referring to FIG. 4, there is shown a schematic representation of a method 200 for improving stability of a ship according to an embodiment of the present invention.

The method 200 comprises mapping and/or modelling 210 an internal geometry and space of the ship. It will be understood that the mapping and/or modelling of the ship will be specific to the ship under study.

Typically, step 210 comprises dividing the ship into a plurality of compartments, and mapping and/or modelling the plurality of compartments.

Step 210 typically comprises mapping and/or modelling the space(s) and/or element(s) within each of the compartments. The space(s) and/or element(s) may comprise equipment including non-buoyant volumes such as tanks, machinery, pipes, and/or other equipment. By such provision an accurate model of the volume available for potential flooding can be created and/or designed. Step 210 typically comprises mapping and/or modelling openings between compartments, such as doors, windows, stairwells, or the like, may cause progressive flooding to a critical region of the ship. By such provision, an accurate model of the potential for progressive flooding can be created and/or designed.

The method 200 comprises performing a vulnerability analysis 220. Typically, step 220 comprises calculating the probability that a ship may capsize within a certain time, based on the map and/or model created in step 210, and on a number of conceivable scenarios involving damage and/or flooding to one or more compartments.

The method 200 comprises performing a sensitivity analysis 230. Typically step 230 comprises identifying and/or ranking compartments where injection of foam may lead to an increase in ship stability.

In this embodiment, the method comprises determining 240 an optimum amount and/or volume of foam to be injected to achieve a predetermined level of increase in ship stability. In this embodiment, step 240 comprises determination of an amount and/or volume of foam to be injected for which buoyancy restoration per volume of foam will lead to maximum increase in stability.

The method 200 comprises detecting 250 damage to a region of a ship, e.g., to one or more compartments.

Following detection 250 of damage to one or more compartments, the method 200 comprises taking an action 260. In this embodiment, step 250 involves a user, such as a crew member, taking an action. The action is typically based on the vulnerability analysis and sensitivity analysis performed in steps 230 and 240.

If the vulnerability analysis and sensitivity analysis reveal a high risk that the ship may be lost following damage, the action taken by the user in step 260 will typically be to inject foam as shown in step 270 in one or more compartments which are most likely to result in the ship being saved.

In one embodiment, step 270 comprises injecting foam in the damaged compartment or compartments. This may be adequate if damage occurs in a critical compartment or critical compartments in order to displace water therefrom and improve stability, or if damage occurs in a compartment or compartments in fluid communication with a critical compartment in order to prevent water from entering the critical compartment.

In another embodiment, step 270 comprises injecting foam in one or more compartments adjacent to and/or in fluid communication with the damaged compartment or compartments. This may be adequate if damage occurs in a non-critical compartment or non-critical compartments in fluid communication with a critical compartment or critical compartments. In such instance, while injection of foam in the non-critical compartment or non-critical compartments may not be required to maintain the overall stability of the ship, injection of foam in the one or more compartments adjacent to and/or in fluid communication with the damaged compartment or compartments prevents water ingress into and/or displaces water from the critical compartment or critical compartments. This may ensure survival of the ship, while minimising the amount of foam injected in the ship, thereby reducing costs and increasing the rapidity of subsequent reinstatement of the ship.

In an alternative embodiment, the action taken by the user in step 260 will typically be not to inject foam 280 in any compartment, e.g., either in a damaged compartment or compartments, or in any compartment or compartments in fluid communication with the damaged compartment or compartments. This may be adequate if damage occurs in a non-critical compartment or non-critical compartments. Since such a scenario would not compromise the overall stability of the ship and would not lead to the loss of the ship, injection of foam is not required. Therefore, avoiding systematic injection of foam following damage to a region of the ship may reduce costs, and substantially quicker subsequent reinstatement of the ship.

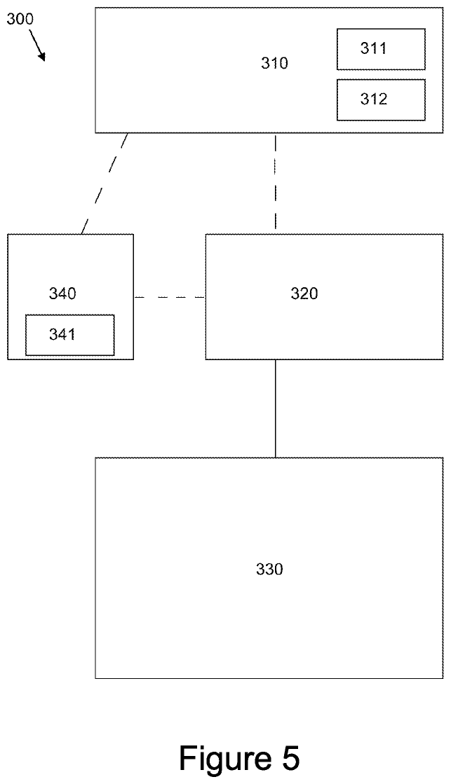

Referring to FIG. 5, there is shown a schematic representation of a system 300 for improving stability of a ship according to an embodiment of the present invention.

The system 300 comprises a computer system 310 configured to determine a location suitable for injection of a foaming composition following an emergency event.

The computer system 310 comprises and/or is equipped with a map and/or model 311 of the ship, e.g. a map and/or model of an internal geometry and/or space of the ship.

The computer system 310 comprises and/or is equipped with data 312 representing one of more ship characteristics. The one or more ship characteristics may comprise overall length, length between perpendiculars, breadth, subdivision draught, lightweight, deadweight, total passengers, and/or total crew.

The computer system 310 is configured to determine the likelihood of the ship surviving damage to one or more compartments, and/or to identify and/or rank compartments where injection of foam may lead to maximum stability recovery.

The computer system 310 is configured to determine a desired and/or minimum amount and/or volume of foam to be injected to achieve a predetermined increase in ship stability. In an embodiment, the computer system is configured to determine an amount and/or volume of foam to be injected for which buoyancy restoration per volume of foam will lead to maximum increase in stability.

The system 300 comprises a detection system 340 which may comprise or consist of one or more sensors 341 configured to detect damage to a region of a ship, e.g., to one or more compartments. In this embodiment, each critical compartment is equipped with a sensor 341.

The system 300 comprises a user interface 320 configured to allow a user to inject a foamable composition in a selected region of a ship. The user interface 320 is configured to allow a user to select one or more compartments where foam is to be injected.

The system 300 comprises an injection system 330 for injecting foam in one or more compartments.

In this embodiment, the user interface 320 is in connected to and/or is in communication with the computer system 310, the detection system 340 and the injection system 330. However, in other embodiments, the user system may be connected to and/or may be in communication with the injection system, while the computer system 310 and/or the detection system 340 may be distinct from the user interface 320. In such instance, a user may use the computer system 310 to obtain access information and data regarding the vulnerability and sensitivity analysis in order to take an action 260.

In an embodiment, the computer system 310 is connected to and/or is in communication with the detection system 340. In such instance, the computer system may be configured to recommend and/or propose an action to be taken by a user, based on the damage detected by the detection system 340, and the vulnerability and sensitivity analysis provided in the computer system 310.

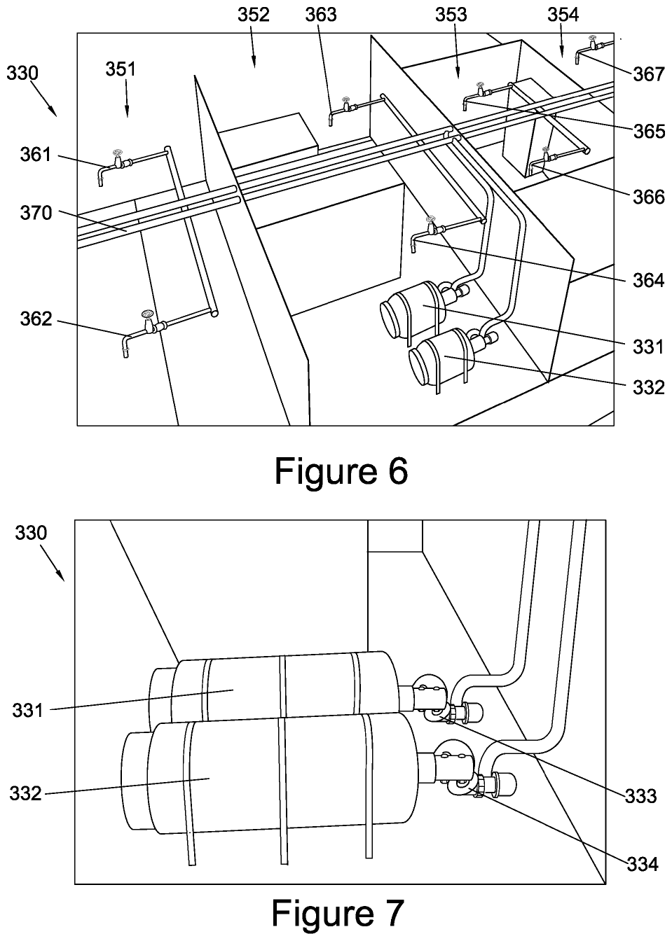

An embodiment of the injection system 330 is best shown in FIGS. 6 and 7.

The injection system 330 comprises containers 331 and 332. Container 331 is configured to store a first composition comprising a polymer or prepolymer, such as a formaldehyde resin. Container 332 is configured to store a second composition comprising a crosslinking composition such as a solution of an acid, e.g. a weak acid, in water.

The injection system 330 system comprises first pump 333 associated with first container 331, and second pump 334 associated with second container 332.

The injection system 330 comprises a network of pipes 370 configured to deliver first and second compositions to a number of compartments 351,352,353,354. In this embodiment, the network of pipes 370 is configured to deliver first and second compositions to a number of compartments 351,352,353,354 from first container 331 and second container 332. However, it will be appreciated that in other embodiments, each compartment may be provided a dedicated first and second containers 331,332 and corresponding network of pipes 370. Any suitable arrangement regarding the number of containers and associated conduits for delivering foam to the various compartments may be envisaged, depending on the size of the vessel, size of the compartments, spatial restrictions, etc.

The injection system 330 comprises discharge devices 361-367, in this embodiment in the form of nozzles, for discharging the foaming composition.

The injection system 330 comprises a gas injection mechanism XXX for providing and/or injecting a gas, e.g., air, carbon dioxide, nitrogen, or the like, to foam and/or to help foam of the composition. In this embodiment, the system 330 comprises a compressor (not shown), configured to supply a gas, e.g. air, in the stream of the first composition and/or second composition.

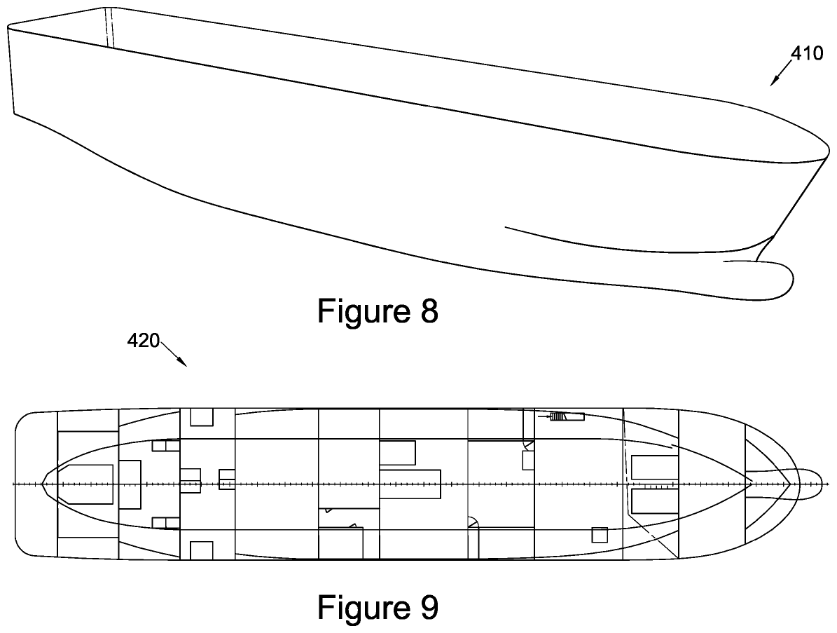

Referring to FIGS. 8-12, there is shown a first embodiment of a sensitivity analysis and implementation of a system and method according to the present invention for a first type of vessel, namely a small RoPax ferry operating within European coastal waters. This vessel can accommodate up to 550 passengers and is operated by a total of 30 crew members. Lifesaving appliances are provided for all 550 persons onboard for domestic voyage, as a Class B vessel according the EU passenger ship directive 2009/45/EC. The vessel has a large hold that spans the length of the vessel in order to accommodate storage and drive through operations of up to a total of 85 cars. Accommodation for passengers is located within the vessel's superstructure although no cabins are provided due to short turnaround times.

The main characteristics of the vessel are as given in table 1.

TABLE 1
Small ROPAX Properties
Main Particulars

| Length Overall | 89.48 | m |
|---|---|---|
| Length Between Perpendiculars | 81.8 | m |
| Breadth | 16.4 | m |
| Design Draught | 3.4 | m |
| Number of Passengers | 550 | |
| Number of Crew | 30 | |
| Cars | 85 | |
| Displacement | 3434.8 | t |
| Deadweight | 740 | DWT |
| Service Speed | 16.3 | Kn |

A computational model 410 of the vessel design, as shown in FIG. 8, was generated in order to conduct damage stability calculations using relevant stability software. The vessel's internal arrangements including rooms, compartments and tanks were also modelled and all relevant openings liable to affect the vessel's range were defined.

The vessel has been divided into a total of 12 independent watertight compartments as shown in the model 420 of FIG. 9.

Damage stability calculations according to SOLAS2009 (MSC.216(82)) were conducted in order to ascertain the safety level of the vessel and also identify potential safety critical areas within the design. The required safety level, as represented by the required subdivision index R, was calculated in accordance to regulation 6 and as outlined below in Equation (1):

$$R = 1 - \frac{5000}{L s + 2.5 N + 15225} \qquad Eq ( 1 )$$

Where

L_{S}=Subdivision Length=89.1 m;

N=N₁+N₂=580;

N₁=Persons in lifeboats=580;

N₂=Persons in excess of N₁=0.

Based on these parameters the required subdivision index R for this vessel was found to be R=0.71.

The vessel's attained subdivision index A was calculated in accordance with SOLAS 2009 regulation 7. As required by this process the vessel was assessed over three loading conditions as outlined in Table 2 below:

TABLE 2

| | Displacement | Draught | GM | KG |
|---|---|---|---|---|
| Loading Condition | (tonne) | (m) | (m) | (m) |
| Light Service Draught | 2728 | 2.845 | 2.374 | 7.584 |
| Partial Subdivision | 3196 | 3.235 | 1.863 | 7.443 |
| Draught | | | | |
| Deepest Subdivision | 3348.79 | 3.43 | 1.704 | 7.338 |
| Draught | | | | |

The results of this process are summarised in Table 3 below:

TABLE 3
Partial & Final Attained Indices - Acc. SOLAS 2009

| | |
|---|---|
| Ballast (dl) | 0.99 |
| Partial Load (dp) | 0.957 |
| Scantling (ds) | 0.933 |
| Attained Subdivision Index (A) | 0.955 |
| Required Subdivision Index (R) | 0.71 |

In order to ascertain where and when it would be best to implement the system of the present invention, it was first necessary to identify high risk areas within the vessels design. The results of the damage stability assessment provide this information and this can be viewed rather transparently using the diagram presented in FIG. 10. Here the survivability factors for varying damage extents are displayed in a colour coded manner where green (G) represents a survivability factor S=1, yellow (Y) a survivability factor 0<S<1, and red (R) a survivability factor S=0.

The results presented in FIG. 10 are those that were found considering maximum penetration damages. In this case safety critical design spots have been identified in damages involving compartments 6, 9 & 10. As such the application of foam injection would be best suited to these compartments as this will yield the highest risk reduction. In order to enhance the efficiency of the expanding foam system it was necessary to consider the volume of foam required to sufficiently reduce the level of risk. It was therefore necessary to establish the nature of the relationship between volume and risk. In order to establish this relationship, firstly, the level of risk inherent to each compartment space needed to be found. This was done through the calculation of the local attained index values of each of the primary 56 spaces. With these values known the effect of implementing the expanding foam system in each space could be found. This was achieved through consideration of the remaining level of risk after having “saved” the respective volumes of each space. This remaining level was risk was calculated as highlighted in equation 2.

R=1−Aiₙ Eq (2)

Where Ai is the local attained index;
n is the space under consideration; and
R is the remaining level of risk.

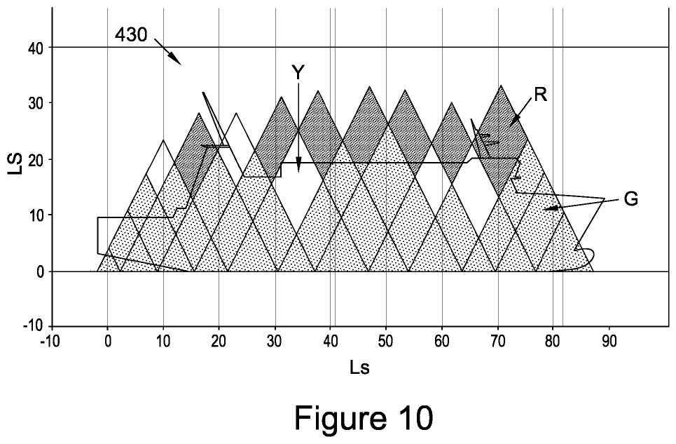

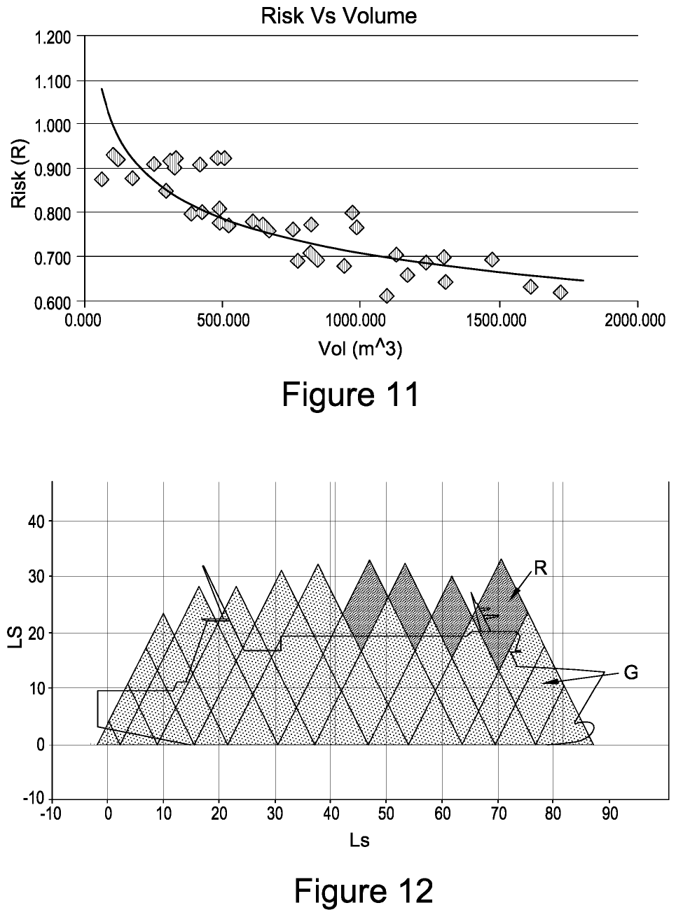

The reduction in risk was then calculated for increasingly larger volumes as to establish how the rate of change in risk varied with increasing volume. This then enable a graph depicting the relationship between risk and volume to be plotted as shown in FIG. 11.

On the basis of the risk/volume function shown in FIG. 11, a total volume of 250 m³ of foam was identified as the optimum quantity for this vessel, as this corresponds to the point of inflexion of the curve.

Having identified vulnerabilities within the vessel's design and having established the necessary parameters for the application of the present method and system, the vessel was re-evaluated in order to ascertain the level of risk reduction offered by the system. This process involved re-simulating the high risk damage cases taking into account the effects of the system of the present invention through altering the permeability of the selected safety critical compartments according to the volume of foam applied. The results of this process are summarised in Table 4.

TABLE 4
Partial Attained Indices - Acc. SOLAS 2009 (DSRD Active)

| | |
|---|---|
| Ballast (dl) | 0.999 |
| Partial Load (dp) | 0.99 |
| Scantling (ds) | 0.98 |
| Attained Subdivision Index (A) | 0.992 |

The results in this case show a total risk reduction of 350%. This is reflected in FIG. 12 where the local survival indices can be compared with the initial condition shown in FIG. 10.

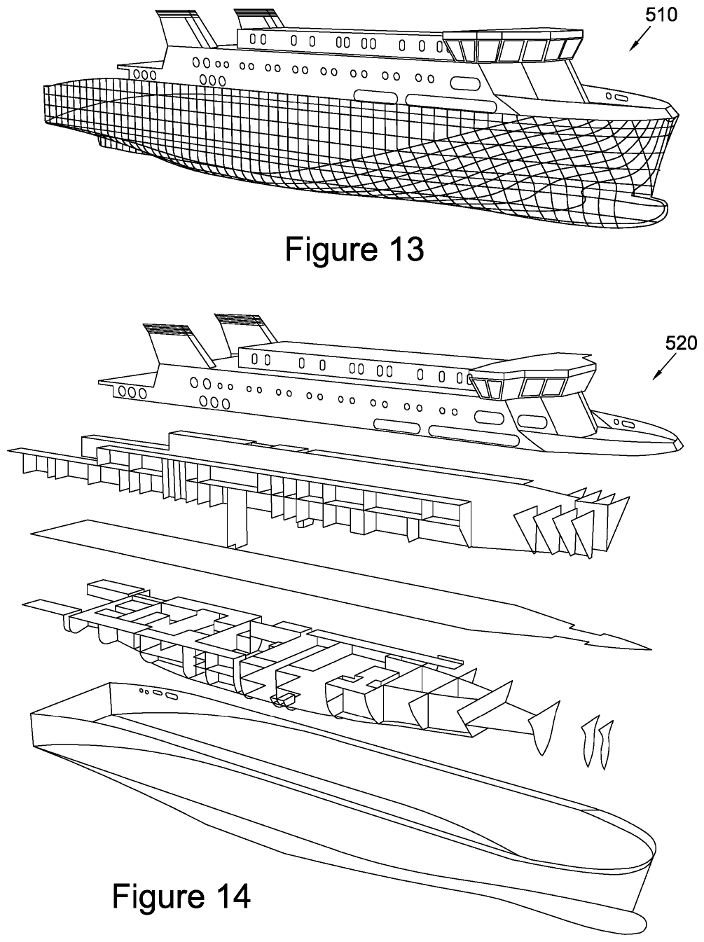

Referring to FIGS. 13-18, there is shown a second embodiment of a sensitivity analysis and implementation of a system and method according to the present invention for a second type of vessel, namely a medium size RoPax ferry operating within European coastal waters. This vessel can accommodate up to 700 passengers and is operated by a total of 43 crew members. Lifesaving appliances are provided for all 743 persons onboard for domestic voyage, as a Class B vessel according the EU passenger ship directive 2009/45/EC. The vessel's main cargo hold is designed for both easy and fast cargo handling with loading and unloading taking place at both the bow and stern (drive through operations). Accommodation for passengers is located within the vessel's superstructure although no cabins are provided due to short turnaround times.

The main characteristics of the vessel are as given in table 5.

TABLE 5
Main Particulars

| Length Overall | 117.9 | m |
|---|---|---|
| Length Between Perpendiculars | 111.45 | m |
| Subdivision Length | 115.5 | m |
| Breadth | 19.2 | m |
| Design Draught | 4.8 | m |
| Number of Passengers | 700 | |
| Number of Crew | 45 | |
| Gross Tonnage | 9058 | |
| Deadweight | 1434 | |
| Service Speed | 19.2 | Kn |
| Main Engine | 8000 | kW |

A computational model 510 of the vessel design, as shown in FIG. 13, was generated in order to conduct damage stability calculations using relevant stability software.

The vessel's internal arrangements including rooms, compartments and tanks were also modelled as shown in model 520 of FIG. 14 and all relevant openings liable to affect the vessel's range were defined.

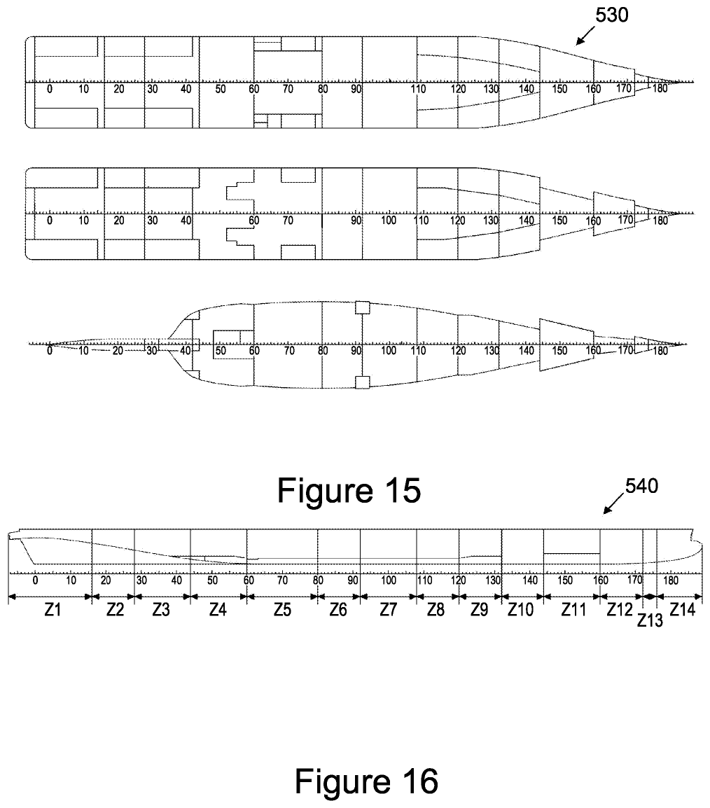

The vessel has been divided in to a total of 14 watertight compartments below the bulkhead deck as shown in the model 530 of FIG. 15.

Damage stability calculations were conducted as per Equation (1) above, in which, in this embodiment:

L_{S}=Subdivision Length=115.5 m;

N=N₁+N₂=745;

N₁=Persons in lifeboats=745;

N₂=Persons in excess of N₁=0.

Based on these parameters the required subdivision index R for this vessel was found to be R=0.71.

The Vessel's attained subdivision index A was calculated in accordance with SOLAS 2009 regulation 7. As required by this process the vessel was assessed over three loading conditions as outlined in Table 6 below:

TABLE 6

| | Displacement | Draught | GM | KG |
|---|---|---|---|---|
| Loading condition | (Tonne) | (m) | (m) | (m) |
| Light Service Draught | 5,226.50 | 4.33 | 1.95 | 8.94 |
| Partial Subdivision | 5,758.80 | 4.64 | 2.13 | 8.84 |
| Draught | | | | |
| Deepest Subdivision | 6,127.60 | 4.85 | 2.27 | 8.61 |
| Draught | | | | |

The subdivision of the vessel was divided into a total of 14 damage zones, as shown in FIG. 16, and a total 1200 damage scenarios were assessed.

The results of this process are summarised in Table 7 below:

TABLE 7
Partial & Final Attained Indices - Acc. SOLAS 2009

| | |
|---|---|
| Ballast (dl) | 0.95 |
| Partial Load (dp) | 0.92 |
| Scantling (ds) | 0.91 |
| Attained Subdivision Index (A) | 0.92 |
| Required Subdivision Index (R) | 0.73 |

The results presented in Table 7 show a large deviation between the required index and the vessel's attained index value.

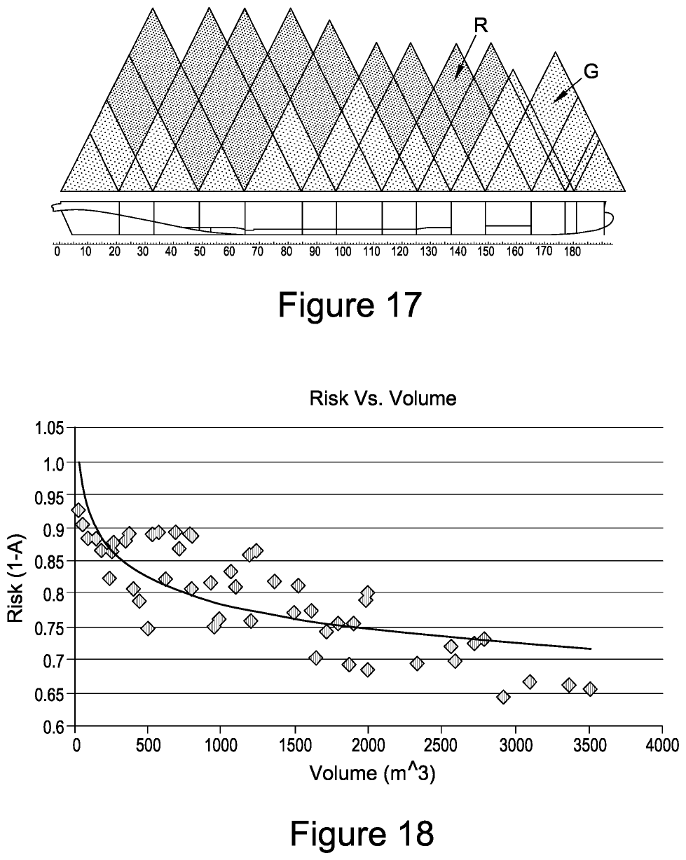

Despite the vessel's high attained index value several safety critical cases were identified. The vessel's risk profile along with the local indices calculated, as shown in FIG. 17, shows a concentration of loss scenarios in damages located towards the aft end of the vessel.

FIG. 17 highlights that the vessel has particular vulnerabilities in respect of damage cases involving compartments 2, 3 & 4.

Having identified appropriate spaces for application of the system and method of the present invention, the most efficient volume of foam to be utilised was calculated. This was achieved through plotting volume as a function of risk, as shown in FIG. 18, and by taking the point of inflection of the function as the optimum quantity.

On the basis of the function shown in FIG. 18, a total volume of 300 m³ was utilised in the case of this vessel. Table 8 below provides a summary of each space subject to the application of the system along with the volume of expanded foam applied in each case and the remaining volume post application.

TABLE 8

| | | Expanded Volume of |
|---|---|---|
| Compartment ID | Volume (m\hat{ }3) | Foam Applied (m\hat{ }3) |
| Steering Gear Room | 317 | 300 |
| Void Space 15 | 350 | 300 |
| Auxiliary Engine Room | 805 | 300 |
| Cooling Systems Room | 387 | 300 |
| Void Space Number 8 | 353 | 300 |
| Fin Stabilizer Room | 51 | 48 |

Having applied the present system to the loss scenarios identified from the initial assessment the vessel was re-assessed in order to produce a new attained index value. The results of this process are summarised in Table 9.

TABLE 9
Partial Attained Indices - Acc. SOLAS 2009 (DSRD Active)

| | |
|---|---|
| Ballast (dl) | 0.97 |
| Partial Load (dp) | 0.95 |
| Scantling (ds) | 0.94 |
| Attained Subdivision Index (A) | 0.95 |

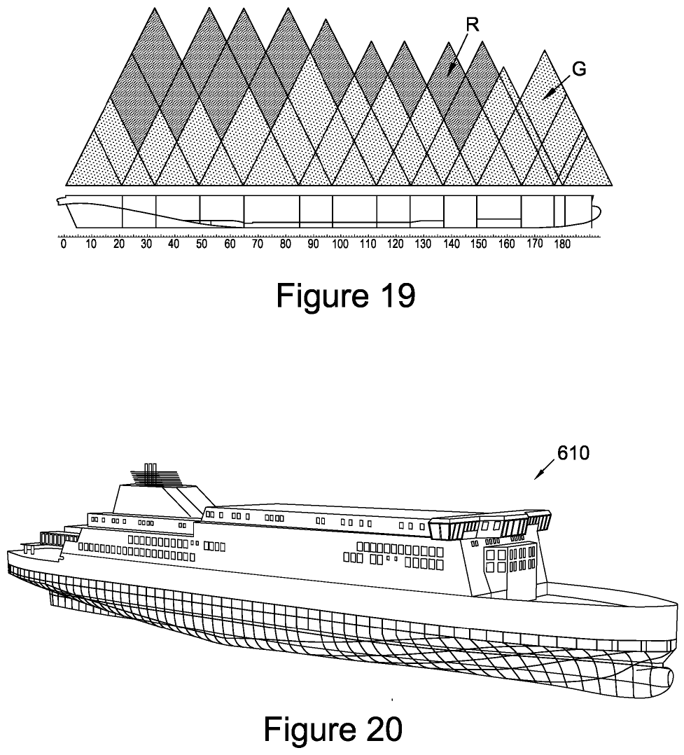

FIG. 19 illustrates the improvements made by highlighting the change in survival factors. In particular, it can be seen by comparing FIG. 17 and FIG. 18 that the survivability factor was greatly increased by the system of the present invention.

Referring to FIGS. 20-25, there is shown a third embodiment of a sensitivity analysis and implementation of a system and method according to the present invention for a third type of vessel, namely a large RoPax ferry operating within European coastal waters. The vessel is designed to operate on short European international voyages and is operated by a total 200 crew and has a passenger capacity of 2000 persons. The vessel has open holds to accommodate the easy on load and offload of cars, trailers and coaches located on decks 3, 5 and 6. Below the bulkhead deck the vessel is subdivided into a total of 17 watertight compartments.

The main characteristics of the vessel are as (liven in table 10.

TABLE 10
Main Particulars

| | | |
|---|---|---|
| Length over all | 179.7 | m |
| Length Between Perpendiculars | 170 | m |
| Breadth Moulded | 27.8 | m |
| Subdivision Draught | 6.419 | m |
| Lightweight | 12500 | t |
| Deadweight | 5394 | t |

| | |
|---|---|
| Total Passengers | 2000 |
| Total Crew | 2200 |

A computational model of the vessel's hull form and internal arrangement was generated for subsequent analysis using relevant stability software. This included the definition of all internal of compartmentation located within the vessel's subdivision and cargo holds and also the definition of all tanks within the vessel. Such computational model 610 is shown in FIG. 20.

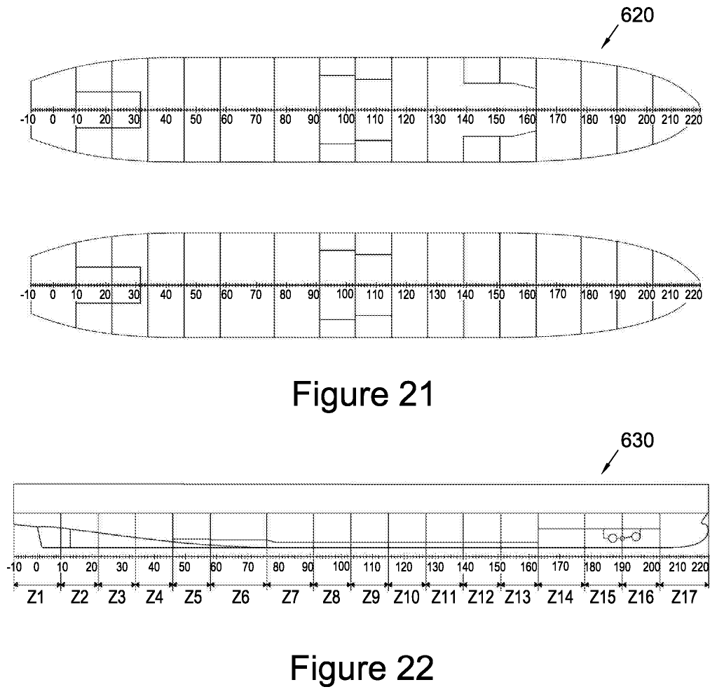

The vessel has been divided in to a total of 17 watertight compartments below the bulkhead deck as shown in the model 620 of FIG. 21.

Damage stability calculations were conducted as per Equation (1) above, in which, in this embodiment:

L_{S}=Subdivision Length=178.1 m;

N=N₁+N₂=2200;

N₁=Persons in lifeboats=1000;

N₂=Persons in excess of N₁=1200.

Based on these parameters the required subdivision index R for this vessel was found to be R=0.81.

The Vessel's attained subdivision index A was calculated in accordance with SOLAS 2009 regulation 7. As required by this process the vessel was assessed over three loading conditions as outlined in Table 11 below:

TABLE 11

| | Displacement | Draught | GM | KG |
|---|---|---|---|---|
| Loading Condition | (tonne) | (m) | (m) | (m) |
| Light Service Draught | 13,983.00 | 5.39 | 4.15 | 12.02 |
| Partial Subdivision | 16,304.00 | 5.99 | 2.84 | 12.91 |
| Draught | | | | |
| Deepest Subdivision | 17,971.00 | 6.42 | 2.91 | 12.57 |
| Draught | | | | |

The subdivision of the vessel was divided into a total of 17 damage zones, as shown in FIG. 22, and a total 3000 damage scenarios were assessed.

The results of the damage stability assessment are provided in Table 12 below:

TABLE 12
Partial & Final Attained Indices - Acc. SOLAS 2009

| | |
|---|---|
| Ballast (dl) | 0.98 |
| Partial Load (dp) | 0.877 |
| Scantling (ds) | 0.815 |
| Attained Subdivision Index (A) | 0.875 |
| Required Subdivision Index (R) | 0.81 |

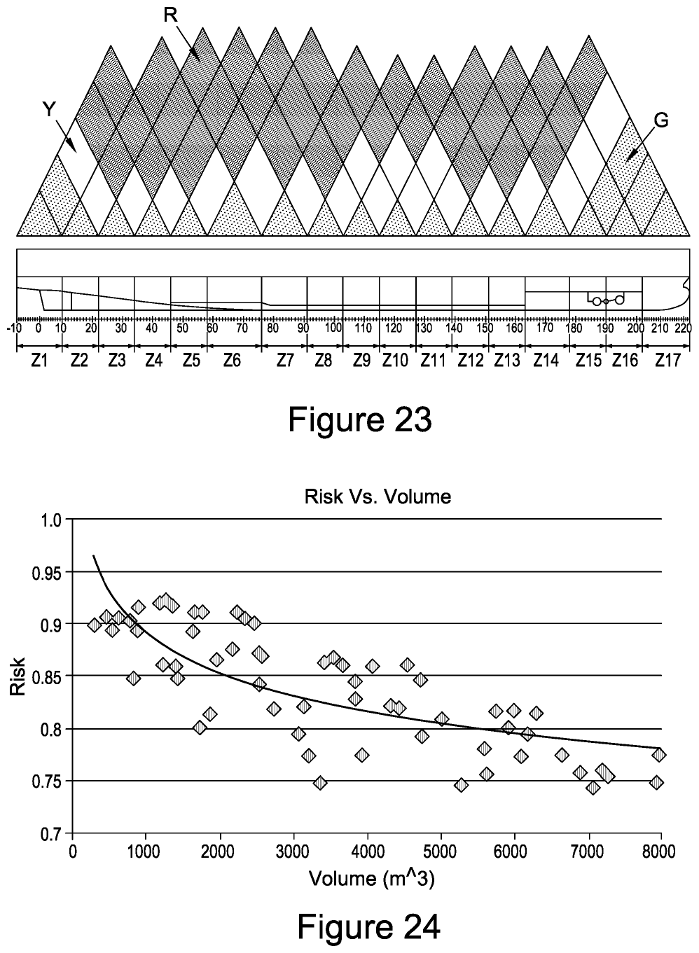

As illustrated by the survival factors shown in FIG. 23, the vessel in question was designed to a two compartment standard. Loss scenarios can be identified for almost all damages comprising three compartments, and two compartment damages also carry risk in most cases. As such, this vessel calls for application of the system and method of the present invention.

As in the previous embodiments, the optimum volume of foam to be used in the present system was determined by the inflection point of the risk/volume function plotted for this vessel, as shown in FIG. 24. In this instance, the optimum volume was found to be 1600 m³.

Having applied the present system to the loss scenarios identified from the initial assessment the vessel was re-assessed in order to produce a new attained index value. The results of this process are summarised in Table 13.

TABLE 13
Partial Attained Indices - Acc. SOLAS 2009 (DSRS Active)

| | |
|---|---|
| Ballast (dl) | 0.989 |
| Partial Load (dp) | 0.9286 |
| Scantling (ds) | 0.89 |
| Attained Subdivision Index (A) | 0.93 |

In this case the implementation of the present system led to a 52% risk reduction over the initial ship design.

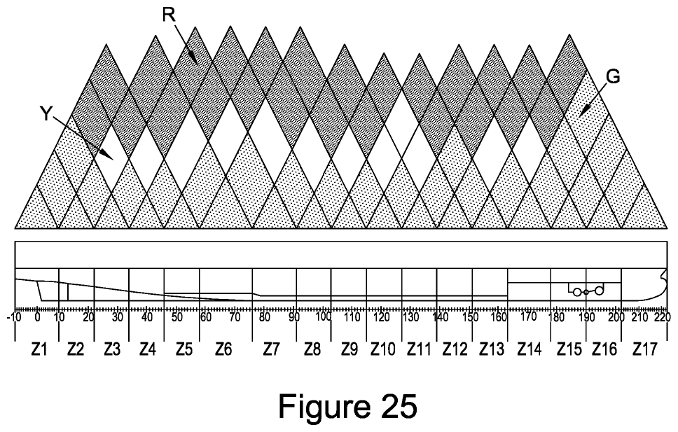

FIG. 25 illustrates the improvements made by highlighting the change in survival factors. In particular, it can be seen by comparing FIG. 24 and FIG. 25 that the survivability factor was greatly increased by the system of the present invention.

Various modifications may be made to the embodiment described without departing from the scope of the invention.

1-54. (canceled)

55. A method of preventing and/or reducing water ingress and/or progressive flooding in a ship, comprising injecting in a region of a ship a foamable composition, the composition being foamable to form a foam, the foam being dissolvable in a removal composition.

56. The method of claim 55, comprising displacing water and/or improving buoyancy and/or stability of a ship.

57. The method according to claim 55, wherein the removal composition comprises an aqueous acid solution.

58. The method according to claim 55, wherein the foamable composition comprises a formaldehyde resin.

59. The method according to claim 55, wherein the foamable composition comprises a resin represented by Formula (I): 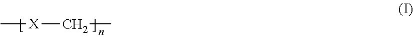
wherein X is selected from the group consisting of:
(i) a urea derivative;
(ii) an optionally substituted aromatic ring, optionally containing one or more heteroatoms; or
(iii) an optionally substituted melamine derivative.

60. The method according to claim 55, wherein the foamable composition comprises one or more selected from the group of a urea-formaldehyde resin, a phenol-formaldehyde resin, a resorcinol-formaldehyde resin, and a melamine-formaldehyde resin.

61. The method according to claim 55, wherein the foamable composition is provided as two or more separate components configured to be mixed and reacted in the region of the ship in which foam is to be injected.

62. The method according to claim 61, wherein a first composition is provided in a first container, wherein the first composition comprises or consists essentially of a polymer or prepolymer.

63. The method according to claim 61, wherein a second composition is provided in a second container, wherein the second composition comprises or consists of a crosslinking composition.

64. The method according to claim 63, wherein the cross-linking composition comprises or consists essentially of an aqueous acid solution.

65. A method of improving stability of a ship, the method comprising identifying one or more regions of the ship where injection of a material may lead to an increase in ship stability, the material being impermeable to water and/or being capable of preventing migration of water.

66. A method according to claim 65, wherein the material comprises a foamable composition.

67. A method according to claim 65, comprising providing a first composition comprising or consisting of a polymer or prepolymer.

68. A method according to claim 67, comprising providing a second composition comprising or consisting of a crosslinking composition.

69. A method according to claim 68, comprising mixing and/or reacting the first composition and the second composition in a region of the ship where the foamable composition is to be injected.

70. A method according to claim 65, comprising the preliminary step of determining a location suitable for injection of the material following damage to a region of the ship.

71. A method according to claim 65, comprising performing a vulnerability analysis.

72. A method according to claim 71, comprising mapping and/or modelling an internal geometry and/or space of a ship, further comprising dividing the internal geometry and/or space of the ship into a plurality of compartments, further comprising mapping and/or modelling one or more spaces and/or elements within each of the compartments, wherein the spaces and/or elements comprise non-buoyant volumes, and openings.

73. A method according to claim 65, comprising determining the likelihood of the ship surviving damage to one or more compartments.

74. A method according to claim 65, comprising identifying and/or ranking compartments where injection of the material leads to maximum stability recovery.

75. A method according to claim 65, comprising determining an amount and/or volume of the material to be injected for which buoyancy restoration per volume of material will lead to maximum increase in stability.

76. A system for improving stability of a ship, the system comprising:
a computer system configured to determine a location suitable for injection of a material following an emergency event; and
a user interface configured to allow a user to inject a material in a region of a ship, the material being impermeable to water and/or being capable of preventing migration of water.

77. A system according to claim 76, wherein the material comprises a foamable composition.

78. A system according to claim 76, wherein the computer system is configured to determine the likelihood of the ship surviving damage to one or more compartments of the ship.

79. A system according to claim 76, wherein the computer system is configured to identify and/or rank regions and/or compartments of the ship where injection of the material leads to maximum stability recovery.

80. A system according to claim 76, wherein the computer system is configured to determine an amount and/or volume of the material to be injected for which buoyancy restoration per volume of material will lead to maximum increase in stability.

81. A system according to claim 76, wherein the user interface is configured to allow a user to select one or more compartments where foam is to be injected.

82. A method of removing a foam from a region of a ship, the method comprising contacting the foam with a removal composition.

83. A method according to claim 82, wherein the method comprises at least one of the step selected from:
(i) applying the removal composition to the foam;
(ii) spraying the removal composition onto the foam; and
(iii) injecting the removal composition into one or more portions of the foam.

84. A method according to claim 82, wherein the removal composition comprises an aqueous acid solution.

85. A foamable composition, the composition being foamable to form a foam, the foam being dissolvable in a removal composition, the foamable composition comprising a formaldehyde resin.
